(19) United States
(12) Patent Application Publication
(10) Pub. No.: US 2018/0370498 A1
(43) Pub. Date: Dec. 27, 2018

(54) GAS COMPRESSION SYSTEM FOR DRYING AT LEAST ONE SENSOR OF A MOTOR VEHICLE

(71) Applicant: Valeo Systèmes d'Essuyage, Le Mesnil Saint Denis (FR)

(72) Inventors: Matthieu Combeau, Issoire (FR); Grégory Kolanowski, Issoire (FR)

(73) Assignee: Valeo Systèmes d'Essuyage, Le Mesnil Saint Denis (FR)

(21) Appl. No.: 16/013,360

(22) Filed: Jun. 20, 2018

(30) Foreign Application Priority Data
Jun. 21, 2017 (FR) 1755656

(51) Int. Cl. B60S 1/56; F04B 9/109; B60S 1/54

(52) U.S. Cl. CPC B60S 1/56; B60S 1/54; F04B 9/109

(57) ABSTRACT

The invention relates to a system (10) for compression of a gas (G) designed to dry at least one sensor (5) of a motor vehicle, comprising:
a pump (2) for injection of a liquid (L) which is designed to pump the liquid from a liquid container (4) to a compressor (1);
the compressor (1) in which the liquid (L) is designed to compress the gas (G); and
at least one element (3) to control a flow of the gas (G), situated downstream from the compressor (1), downstream being understood as a direction (S2) of circulation of a compressed gas (G) in the compression system (10) which permits or prevents circulation of the gas (G) selectively in the direction of the at least one sensor (5).

The present invention relates to the field of driving assistance devices, and more particularly to the field of sensors which are used for this purpose, such as viewing means, in particular cameras, or means for detection by electromagnetic waves, in particular radars or lidars. In this field, the invention concerns more particularly the drying devices which are used after such viewing means are cleaned.

Sensors equip an increasingly large number of motor vehicles in order to assist the driver of the vehicle in certain driving situations, one well-known one of which is assistance with parking. In order for this assistance to be as efficient as possible, the images provided by the viewing means, or the data transmitted by the radars for example, must be of the best possible quality, and it is therefore essential to have faces of these sensors, facing towards the exterior of the vehicle, which are clean. For this purpose, a device for cleaning the sensor can be associated with this sensor, and controlled in order to inject a flow of cleaning fluid onto the said sensor during a period when there is no detection.

In addition, after the sensors have been cleaned, it is advantageous to dry them quickly in order to prevent any risk of pollution of the image by any traces which such a liquid could leave (drops, dribbles, etc.). For this purpose, spraying of a gaseous fluid such as air onto the sensor is provided. This air can be sprayed by a drying device, which would be a supplement to the cleaning device, or it can also be implemented by the cleaning devices which permit the injection of different types of liquid or gaseous fluids, in order to ensure the cleaning then the drying.

At present, the sensors are dried by means of a compression system comprising a compressor with a membrane of the air/air type. This type of compressor uses the principle of continuous blowing, which does not make it possible to achieve pressures sufficient to dry the sensor without leaving traces. In fact, the air pressure at the output of a compressor of this type is approximately 0.2 bar, and is insufficient for optimum drying. In addition, in order to achieve this pressure, a compression system of this type requires the presence of an air container dedicated to the compressor with a membrane. Taking into account the design of new vehicles with less space available under the bonnet, the incorporation of a container of this type makes it necessary to rethink the organisation under the bonnet, and poses a problem of size.

In addition, as well as being cumbersome and not powerful, this type of compressor generally has a limited service life. In fact, after a certain number of cycles, the membrane of the compressor tends to deteriorate. Thus, the service life of the compressor is limited to the service life of the membrane.

The objective of the present invention is to optimise the drying of the sensors, in terms of both drying performance and size.

For this purpose, the present invention relates to a system for compression of a gas designed to dry at least one sensor of a motor vehicle, comprising:
a compressor in which a liquid is designed to compress the gas;
a pump for injection of the liquid which is designed to pump the liquid from a liquid container to the compressor; and
at least one element to control a flow of the gas, situated downstream from the compressor, downstream being understood as a direction of circulation of a compressed gas in the compression system which permits or prevents circulation of the gas selectively in the direction of the at least one sensor.

A compression system of this type with a compressor of the liquid/gas type makes it possible to obtain high gas pressures allowing the sensor(s) to be dried efficiently and without leaving traces. In addition, the liquid container which can be used to obtain these pressures can be a container which already exists in the vehicle. Thus, a compression system of this type is simpler to incorporate than the compression system according to the prior art, and makes it possible to eliminate the problem of size.

Furthermore, this type of compressor does not use a membrane, which makes it possible to extend its service life.

It should be noted that the element for control of the flow makes it possible to ensure the compression of the gas upstream when it prevents the circulation of the gas in the direction of the at least one sensor.

It is understood that a vehicle sensor is defined as a detection element which provides an electrical signal proportional to a physical value to be measured. More specifically, this sensor is designed to ensure functions of detection around the vehicle. For this purpose, a sensor of this type is disposed on the vehicle bodywork, and faces towards the exterior of the vehicle.

According to one or more characteristics of the invention which can be taken alone or in combination, the following are possible:
the injection pump is reversible, such as to permit aspiration of the liquid present in the compressor. A reversible pump of this type allows the compression system to return to its initial position in order to carry out a new drying cycle. The use of such a reversible pump makes it possible to improve efficiency. This reversible injection pump permits aspiration of the liquid from the compressor and to the liquid container;
the liquid is non-compressible. Thus, the compression of the liquid of this type makes it possible to act on the compressor, for example by making it possible to displace a piston inside the compressor arranged between this liquid and the gas to be compressed. A liquid of this type is for example oil or windscreen washer liquid;
the gas is air;
the compressor comprises a piston delimiting a first chamber for the liquid and a second chamber for the gas, the piston being designed to be displaced according to a volume of liquid present in the first chamber;
the piston is free. This means that the piston does not comprise a guide means designed to accompany it during its displacement in the compressor;
the compressor comprises a means for guiding the piston designed to accompany the displacement of the piston along its course;
the guide means is a retractable rod which is integral with the piston;
the guide means is a tongue and groove pair. More specifically, one of the elements of the tongue and groove pair is on the piston and the other is on the compressor, in particular on an inner face of the compressor along which the piston slides;
the piston is designed to slide in the compressor in a sealed manner, in order to prevent passage of liquid and/or gas between the first chamber and the second chamber;
the compressor has a maximum volume of 150 cm³;
the element for control of the flow of the gas is a solenoid valve. The use of a solenoid valve rather than a discharge valve, for example, has the advantage that it is able to be controlled electronically so that its opening and closure can be programmed;
the at least one element for control of the flow of the gas is configured to permit the circulation of the gas in the direction of the at least one sensor, when pressure of the gas is equal to at least 2 bars. More specifically, the pressure of the gas is measured in a space situated between the compressor and the element for control of the flow of gas, or in a space comprising the second chamber of the compressor, and a duct connecting the compressor to the element for control of the flow of the gas. In both cases, the pressure measurement is representative of the pressure of the compressed gas. Such a pressure, of at least 2 bars, makes it possible to ensure that the drying of the sensor is optimal, and that no traces and dirt are left;
the compression system comprises a pressure sensor situated between the compressor and the at least one element for control of a flow of the gas;
the compression system comprises at least one vent, such as to introduce a non-compressed gas into the compressor. More specifically, the presence of this vent makes it possible to introduce external air easily into the second chamber of the compressor;
the vent is equipped with an air filter;
the vent is equipped with a unit for control of a flow of the gas, designed such as to prevent passage of the compressed gas towards the vent, and to permit passage of the non-compressed gas from the vent to the compressor;
the unit for control of a flow of the gas with which the vent is equipped is a non-return valve;
the vent is situated between the compressor and the at least one element for control of the flow;
the compression system comprises a gas heating device which is designed to ensure a function of defrosting of the at least one sensor;
the gas heating device is situated between the compressor and the element for control of the flow of the gas, or in a space comprising the second chamber of the compressor and a duct connecting the compressor to the element for control of the flow of the gas. In other words, the gas heating device is situated at the level of the compressed gas;
the gas heating device is a resistor.

The invention also relates to an assembly for compression of a gas designed to dry at least one sensor of a motor vehicle comprising: a liquid container and a compression system, characterised in that the compression system is as previously defined.

According to one or more embodiments, the following are possible:
the compression assembly comprises a container for liquid situated upstream from the injection pump of the compression system, downstream being understood according to a direction of injection of the liquid. This container constitutes a container dedicated to the compression system according to the invention;
the container for liquid of the compression assembly is a windscreen washer liquid container of the motor vehicle. This windscreen washer liquid container is designed to supply a device for spraying fluid in the direction of the sensors and/or the glass surfaces of the vehicle, the windscreen washer liquid also being the liquid which is designed to compress the gas in the compressor. The use of a windscreen washer liquid container of this type within the context of the invention makes it possible to eliminate the problems of size encountered with the compression systems according to the prior art.

The invention also relates to an assembly for spraying a fluid in the direction of a sensor of a motor vehicle, comprising a device for spraying the fluid designed to be directed towards the sensor, and a compression system, the spraying device being connected to the compression system, characterised in that the compression system is as previously defined.

According to one or more embodiments, the following are possible:
the spraying device is situated downstream from the at least one element for control of the flow of gas of the compression system, downstream being understood according to the direction of circulation of the compressed gas in the compression system, such as to ensure drying of the sensor;
the fluid designed to be sprayed by the spraying device is a gas in order to dry the sensor. The gas is for example air;
the spraying device is also configured to spray liquid in order to clean the sensor. The liquid is advantageously windscreen washer liquid.

Other characteristics and advantages of the present invention will become more apparent from the following description and the drawings in which:

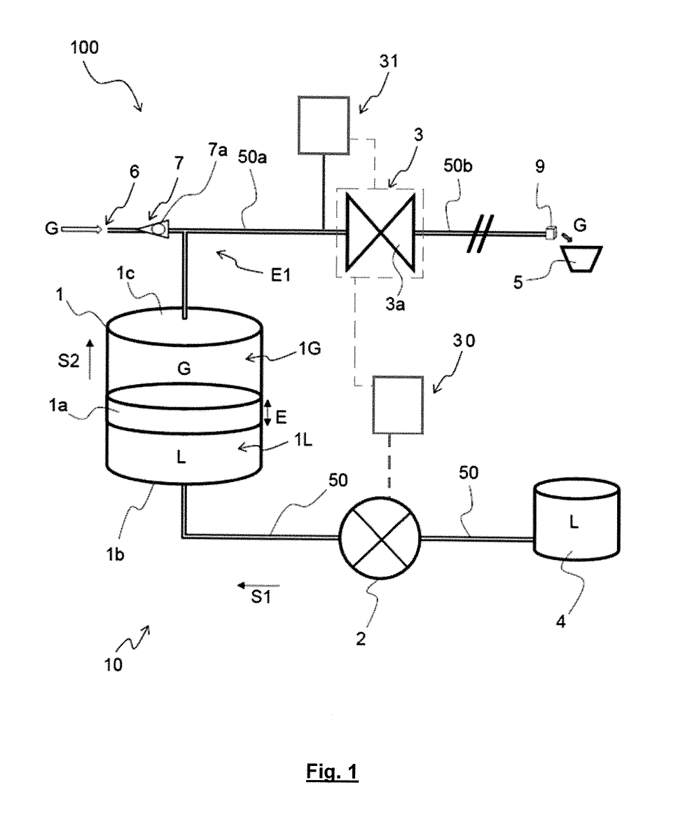

FIG. 1 is a schematic representation of a circuit for drying at least one sensor of a motor vehicle, comprising a compression system according to the present invention; and

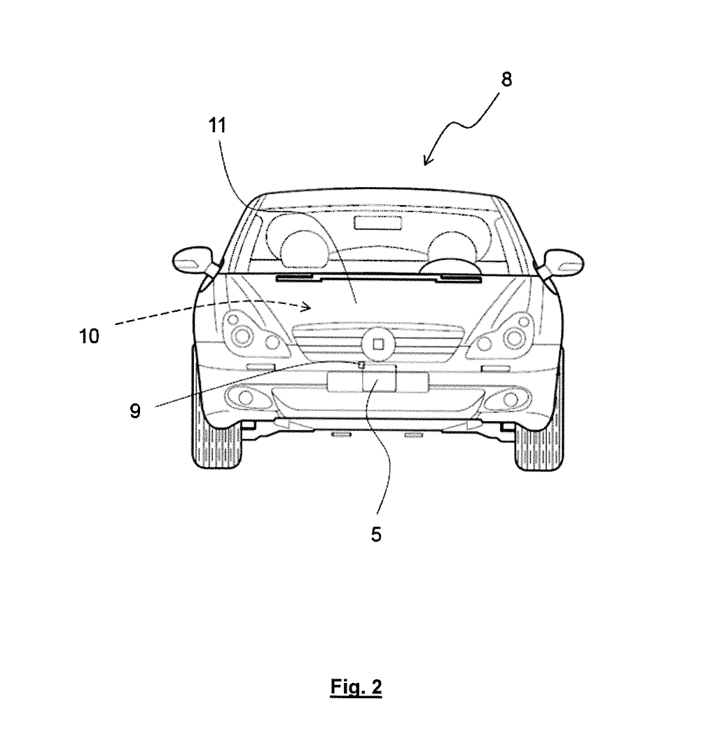

FIG. 2 is a front view of a motor vehicle comprising the compression system according to the present invention.

It should firstly be noted that the figures disclose the invention in a detailed manner for implementation of the invention, and it will be appreciated that the said figures can be used to define the invention better if applicable. However, it should be noted that these figures disclose only some of the embodiments which are possible according to the invention.

FIG. 1 shows a circuit 100 for drying at least one sensor 5 of a motor vehicle, comprising a system 10 for compression of a gas G designed to dry the sensor(s) 5. The compression system 10 comprises a compressor 1, an injection pump 2, and at least one element 3 for controlling the flow of the gas G. It will be appreciated that ducts 50, 50a, 50b are provided in order to connect these different elements to one another.

The compressor 1 is of the liquid/gas type, in which the liquid L is designed to compress the gas G. According to the embodiment illustrated, the compressor 1 is in the form of a cylinder. It will be appreciated that any other form of the compressor 1 which permits compression of the gas G by the liquid L could be provided. It should also be noted that this compressor 1 has a volume of 150 cm³, to within the production tolerances, thus making it possible to ensure optimal drying of the sensor 5 without leaving traces or dirt.

The compressor 1 comprises a piston 1a which makes it possible to define a first chamber 1L for the liquid L and a second chamber 1G for the gas G. The piston 1a is displaced from one end 1b to the other 1c of the compressor 1, according to the volume of liquid L admitted into the compressor 1. Depending on the direction of displacement of the piston 1a, the latter compresses the gas G or aspirates gas G, as will be described hereinafter. Preferably, the piston 1a slides in the compressor in a sealed manner, in order to prevent passage of fluid between the two chambers 1G, 1L. It should be noted that the ends 1b, 1c of the compressor are opposite one another along the axis of displacement of the piston 1a. A distinction is thus made between a first end 1b of the compressor 1 situated as close as possible to an orifice for the liquid L, and a second end 1c as close as possible to an orifice for the gas G.

The piston 1a can have different forms. According to the embodiment illustrated, the piston 1a is free, in the sense that it is not connected to a guide means. In this case, the thickness E of the piston 1a is large enough to prevent the piston 1a from becoming misaligned, deformed, or overturning under the effect of the pressure and the displacement.

According to a variant embodiment, the piston 1a cooperates with a guide means, in order to prevent the piston from becoming misaligned, deformed, or overturning under the effect of the pressure. A guide means of this type is in the form of a tongue and groove pair ensuring a slide connection between the piston 1a and the compressor 1. For example, the first chamber 1L comprises at least two grooves extending parallel to the direction of displacement of the piston 1a, and cooperating with two tongues provided on a periphery of the piston 1a. The guide means can also take the form of a rod which is retractable into the compressor 1a. For example, this retractable rod is integral with the piston 1a and is supported on one 1b or the other 1c of the ends of the compressor 1. The retractable rod is for example telescopic.

In addition, the injection pump 2 makes it possible to convey liquid L in the direction of the compressor 1. For this purpose, the injection pump 2 is connected firstly to a liquid container 4 and secondly to the compressor 1. Advantageously, the injection pump 2 is reversible, such as to permit aspiration of the liquid L from the compressor 1 to the liquid container 4, as will be described hereinafter.

The circuit 100 comprises a liquid container 4 which can be dedicated to the compression system 10, or can already exist in the motor vehicle. In both cases, the liquid container 4 is situated upstream from the injection pump 2, upstream being understood according to a direction S1 of injection of the liquid L. It will be appreciated that, from the point of view of size, it is advantageous to use a liquid container 4 which already exists in the motor vehicle. In this case, the liquid container 4 is for example the windscreen washer liquid container designed to supply a device which ensures the cleanness of the sensors and/or of the glass surfaces of the motor vehicle, the windscreen washer liquid then being the liquid L which is designed to compress the gas G in the compressor 1.

More specifically, the liquid L which is designed to compress the gas G in the compressor 1 is non-compressible, such that the piston 1a can be displaced and the gas G situated in the second chamber 1G of the compressor 1 can be compressed. For example, this liquid L is windscreen washer liquid, oil, water, or coolant liquid. It should be noted that the gas G is advantageously air. It will be appreciated that, depending on the drying needs, a gas other than air could be provided. In this case, the compression system 10 would operate with this same gas, under different states of compression.

In addition, in order to participate in the compression of the gas G, an element 3 for control of the flow of the gas G is arranged downstream from the compressor 1, downstream being understood according to a direction S2 of circulation of the compressed gas G in the compression system 10. According to a variant embodiment, the element 3 for control of the flow of the gas G is disposed directly at the output of the second chamber 1G of the compressor 1. This element 3 for control of the flow permits or prevents selectively circulation of the gas G in the direction of the sensor 5. This element 3 for control of the flow is configured to permit circulation of the gas G in the direction of the sensor 5 when the pressure reached by the compressed gas G is equal to at least 2 bars. It should be noted that the ejection of the gas G at a pressure of 2 bars onto the sensor 5 makes it possible to dry the sensor efficiently without risk of traces or residues of liquid.

The element 3 for control of the flow is for example a solenoid valve 3a which is configured to be controlled electronically in order to programme its opening and closure.

In order to activate the solenoid valve 3a so that it permits the circulation of the gas G in the direction of the sensor 5, the compression system 10 comprises a computer 30 which makes it possible to assess the pressure reached according to the duration of operation of the injection pump 2. For example, this computer is based on theoretical values which make it possible to confirm that, at the end of 2 to 4 seconds of operation of the injection pump 2, the pressure of the compressed gas G situated upstream from the solenoid valve 3a is 2 bars or more.

According to a variant embodiment, the compression system 10 comprises a pressure sensor 31, which in this case is disposed between the compressor 1 and the element 3 for control of the flow of the gas G. This pressure sensor makes it possible to activate the element 3 for control of the flow when the pressure of the compressed gas G is 2 bars or more. More specifically, the pressure of the gas is measured between the compressor 1 and the element 3 for control of the flow of gas, or in a space E1 comprising the second chamber 1G of the compressor 1 and a duct 50a which connects the compressor 1 to the element 3 for control of the flow of the gas G. In both cases, the pressure measurement is representative of the pressure of the compressed gas G.

It is understood from the preceding paragraphs that although the computer 30 and the pressure sensor 31 are represented in the same figure, they can be implemented independently from one another in the compression system 10, provided that they permit optimised control of the solenoid valve 3a, in this case forming the element 3 for control of the flow.

A description will now be provided of an embodiment of a circuit 100 of this type within the context of the drying of the sensor 5.

After activation of the compression system 10, on demand by a user or after a cycle of cleaning of the sensor 5, the injection pump 2 conveys windscreen washer liquid L from the windscreen washer liquid container 4 to the compressor 1. The intake of the windscreen washer liquid L in the first chamber 1L of the compressor 1 makes it possible to displace the piston 1a to the first end 1c, in the direction of the second chamber 1G containing the gas G, such as, for example, air.

The element 3 for control of the flow, which in this case is in the form of a solenoid valve 3a, is deactivated, in the sense that it prevents the circulation of the air in the direction of the sensor 5. The windscreen washer liquid L which continues to fill the first chamber 1L of the compressor 1 then makes it possible to compress the air blocked in the space E1 comprising the second chamber 1G and the duct 50a which connects the compressor 1 to the solenoid valve 3a. The reduction in the space E1 makes it possible to increase the pressure of the air trapped in this space E1.

It should be noted that, according to the performance of the injection pump 2, such as its flow, the duration of operation of the injection pump 2 varies in order for the air to be at a pressure of 2 bars. According to one embodiment, after three seconds of operation of the injection pump 2, the air is at a pressure of 2 bars, which permits activation of the solenoid valve 3a, in the sense that it opens such as to allow the air to pass in the direction of the sensor 5.

It can be noted that the solenoid valve 3a is connected to the sensor 5 by means of a duct 50b which supplies a device 9 for spraying of fluid directed towards the sensor 5, in order to spray fluid so as to clean and dry the sensor 5. It will be appreciated that a plurality of sensors 5 can be linked to the solenoid valve 3a. For this purpose, the solenoid valve 3a would be connected to a network of ducts 50b, each designed to inject air in the direction of different sensors 5. In this case of application, in order for the air pressure to be sufficient to ensure efficient drying of each of the sensors 5, the compressor 1 would be oversized and the duration of filling with liquid L would be extended.

According to a variant embodiment, the compressor 1 is connected to a plurality of solenoid valves 3a, each designed to permit or prevent the passage of the gas G in the direction of one of the ducts 50b which permit drying of one or a plurality of sensors 5. This variant embodiment has the advantage of being able to select the sensor 5 to be dried according to the solenoid valve which it is decided to activate.

Another variant embodiment consists of disposing a plurality of undersized compressors 1 downstream from the same injection pump 2, downstream being understood according to the direction S1 of injection of the liquid L. Each of the compressors 1 then cooperates with a dedicated solenoid valve 3a which supplies with air a duct 50b facing towards one of the different sensors 5.

In all cases, once the drying of the sensor 5 has been carried out, the piston 1a must return to its initial position in order to begin a new cycle. For this purpose, the injection pump 2 operates in the inverse sense such as to aspirate liquid L from the compressor 1 to the liquid container 4. Operation of this type of the pump 2 in the inverse sense serves the purpose of introducing air into the second chamber 1G of the compressor 1. For this purpose, and according to the embodiment illustrated, the compression system 10 comprises a vent 6 which makes it possible to introduce external air easily into the second chamber 1G of the compressor 1. This vent 6 is situated between the compressor 1 and the solenoid valve 3a. In order to prevent pollution of the compression system 10, the vent 6 can be equipped with an air filter.

Thus, during the aspiration by the injection pump 2, the windscreen washer liquid L is returned to the windscreen washer liquid container 4. The output of the windscreen washer liquid L from the first chamber 1L of the compressor 1 makes it possible to displace the piston 1a from the second chamber 1G to its initial position, i.e. in the direction of the first chamber 1L. The displacement of the piston 1a to its initial position creates low pressure, thus making it possible to aspirate air exterior air via the vent 6. According to a variant embodiment, the compression system 10 does not comprise a vent 6, and the exterior air is aspirated from the sensor 5, via the duct 50b, with the solenoid valve 3a in the open position.

It should be noted that, in order to avoid leakage of compressed air during the compression via the vent 6, the latter is equipped with a unit 7 for controlling a flow of the gas G. For example, this unit 7 for controlling the flow is a non-return valve 7a. The non-return valve 7a is thus arranged such as to prevent the passage of the compressed gas G to the vent 6, and to permit the passage of a non-compressed gas, such as exterior air, from the vent 6 to the compressor 1. In other words, the non-return valve 7a makes it possible to permit passage in a first direction and prevent this passage in a second direction, opposite the first direction.

Once the initial position of the piston 1a has been reached, the injection pump 2 is deactivated. For this purpose, the compression system 10 comprises a computer which makes it possible to assess the position reached by the piston 1a according to the duration of operation of the injection pump 2. For example, this computer is based on theoretical values which make it possible to confirm that after 2 to 4 seconds of operation of the injection pump 2, the piston 1a has reached its initial position. According to a variant embodiment, the compression system 10 comprises a position sensor disposed in the compressor 1. This position sensor makes it possible to deactivate the injection pump 2 when the piston 1a has reached its initial position.

According to a variant embodiment, the injection pump 2 is not reversible, and the piston 1a resumes its initial position by means of a duct for discharge of the liquid L disposed between the injection pump 2 and the compressor 1, the duct for discharge of the liquid L being open after the drying of the sensor 5. According to another variant embodiment, the piston 1a is equipped with a return spring, which permits its return to position on the side of the first end 1b of the compressor 1. In this case, a duct for discharge of the liquid L can be provided between the injection pump 2 and the compressor 1.

The compression system in this state is then ready to begin a new drying cycle.

It should be noted that, advantageously, this compression system 10 is also designed for a function of defrosting of the sensor 5. In fact, according to the laws of thermodynamics which establish the link between pressure and heating coefficient, it is found that during the compression of the air at ambient temperature, the heating coefficient is greater than 1. This means that the compressed air is heating up. However, when the air is expanded, it cools down, but the temperature difference between the compressed air and expanded air remains positive, which means that even after air is released in the direction of the sensor 5 by the solenoid valve 3a, this air is hotter than the exterior air. In other words, the compression of the gas G which is projected onto the sensor 5 participates in heating the sensor, and, according to the invention, the compressor 1 of a liquid/gas type makes it possible to compress the gas G beyond 2 bars, and therefore to increase the temperature of the gas G substantially. Even if the gas G is expanded during its circulation downstream from the element 3 for control of the flow, the gas G blown onto the sensor 5 is hot enough to provide a defrosting effect.

In order to accentuate the heating of the gas G, a heating device, such as a resistor, can be installed between the second chamber 1G of the compressor 1 and the sensor 5, or at the space E1 of the compression system 10. It will thus be understood that this additional heating device is less energy-consuming than a resistor placed in a location where the air would not be compressed.

FIG. 2 shows a motor vehicle 8 comprising a device 9 for spraying of fluid oriented towards a sensor 5. This spraying device 9 cooperates with the compression system 10 situated under the bonnet 11, in order to ensure at least the drying of the sensor 5 by sending a fluid of a gaseous type to the sensor 5. According to an advantageous embodiment of the invention, the spraying device 9 is also configured to ensure the cleaning of the sensor 5 in addition to the drying, by spraying a fluid of a liquid type onto the sensor 5. In other words, the spraying device 9 is designed to discharge both liquid L and gas G onto the sensor 5. For this purpose, the spraying device 9 is connected to the compression system 10 on the one hand and to a system for pumping of liquid on the other hand.

The foregoing description explains clearly how the invention makes it possible to achieve the objectives established, and in particular to propose a compression system 10 which is more efficient, is smaller, and has a better service life than the one according to the prior art. In addition, a compression system 10 of this type is also designed for the replacement market. For this purpose, the compression system 10 is connected firstly to the windscreen washer liquid container which exists in the vehicle, and secondly to a connection joining piece of the spraying device 9.

The invention as has been described is not limited exclusively to the means and configurations described and illustrated, and also applies to any equivalent means or configurations, and any combination of such means or configurations. Similarly, although the invention has been described according to variant embodiments which each implement separately a type of arrangement of the elements which constitute the compression system 10, it will be appreciated that these different arrangements can be combined with one another without detracting from the invention.

1. A system for compression of a gas configured to dry at least one sensor of a motor vehicle, comprising:
a compressor in which a liquid is designed to compress the gas;
a pump for injection of a liquid which is designed to pump the liquid from a liquid container to the compressor; and
at least one element to control a flow of the gas, situated downstream from the compressor, downstream being understood according to a direction of circulation of a compressed gas in the compression system which permits or prevents circulation of the gas selectively in the direction of the at least one sensor.

2. The system for compression according to claim 1, wherein the injection pump is reversible, such as to permit aspiration of the liquid from the compressor.

3. The system for compression according to claim 1, wherein the compressor comprises a piston delimiting a first chamber for the liquid and a second chamber for the gas, the piston being designed to be displaced according to a volume of liquid present in the first chamber.

4. The system for compression according to claim 1, wherein the element for control of the flow of the gas is a solenoid valve.

5. The system for compression according to claim 1, wherein the at least one element for control of the flow of the gas is configured to permit the circulation of the gas in the direction of the at least one sensor, when pressure of the gas is equal to at least 2 bars.

6. The system for compression according to claim 1, further comprising at least one vent, such as to introduce a non-compressed gas into the compressor.

7. The system for compression according to claim 6, wherein the vent is equipped with a unit for control of a flow of the gas, to prevent passage of the compressed gas towards the vent, and to permit passage of the non-compressed gas from the vent to the compressor.

8. The system for compression according to claim 6, wherein the vent is situated between the compressor and the at least one element for control of the flow of gas.

9. An assembly for compression of a gas designed to dry at least one sensor of a motor vehicle comprising: a liquid container and a compression system, wherein the compression system is as defined according to claim 1.

10. An assembly for spraying fluid in the direction of a sensor of a motor vehicle, comprising:
a device for spraying fluid designed to be directed towards the sensor; and
a compression system as defined according to claim 1,
the spraying device being connected to the compression system.
